(19) United States
(12) Patent Application Publication
(10) Pub. No.: US 2025/0194761 A1
(43) Pub. Date: Jun. 19, 2025

(54) UMBRELLA MOUNT FOR A VEHICLE HITCH

(71) Applicants: Clint McLean, Rupert, ID (US); Wendy McLean, Rupert, ID (US)

(72) Inventors: Clint McLean, Rupert, ID (US); Wendy McLean, Rupert, ID (US)

(21) Appl. No.: 18/538,862

(22) Filed: Dec. 13, 2023

(51) Int. Cl. A45B 11/00; B60R 9/06; B60R 11/00

(52) U.S. Cl. CPC A45B 11/00; B60R 9/06; B60R 2011/004; B60R 2011/005

(57) ABSTRACT

An umbrella mount apparatus for mounting an umbrella to a vehicle hitch includes a hitch beam sized and configured to be received into a receiver tube of the vehicle hitch. The hitch beam has a hole extending therethrough near a first end of the hitch beam. The hole is positioned and configured to mount to the receiver tube via a hitch pin. An umbrella-holding tube is coupled to the hitch beam at a second end of the hitch beam opposite the first end. The umbrella-holding tube defines a channel sized and configured for receiving a shaft of an umbrella therethrough. The channel has an open top end and an open bottom end. A retainer is configured to be operable to secure the shaft of the umbrella in a desired position in the umbrella-holding tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to umbrella mounts and more particularly pertains to a new umbrella mount for mounting an umbrella to a vehicle hitch.

### (2) Description of Related Art Including Information Disclosed Under 37 CFR 1.97 and 1.98

When tailgating, camping, or the like, it may be desirable to mount an umbrella to the hitch of a vehicle to provide protection from weather such as sunshine, rain, or the like. Various mounting apparatuses are available for mounting an umbrella in this manner. However, the prior art fails to describe such an apparatus which includes an umbrella-holding tube with open top and bottom ends. Such an apparatus allows for positioning the umbrella along a greater range of positions than extant devices, including facilitating resting the umbrella on a support surface below the device.

### BRIEF SUMMARY OF THE INVENTION

An embodiment of the disclosure meets the needs presented above by generally comprising a hitch beam sized and configured to be received into a receiver tube of a hitch of a vehicle. The hitch beam has a hole extending therethrough near a first end of the hitch beam. The hole is positioned and configured to mount to the receiver tube via a hitch pin. An umbrella-holding tube is coupled to the hitch beam at a second end of the hitch beam opposite the first end. The umbrella-holding tube defines a channel sized and configured for receiving a shaft of an umbrella therethrough. The channel has an open top end and an open bottom end. A retainer is configured to be operable to secure the shaft of the umbrella in a desired position in the umbrella-holding tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an umbrella mount apparatus according to an embodiment of the disclosure.

FIG. 2 is a front view of an embodiment of the disclosure.

FIG. 3 is a side view of an embodiment of the disclosure.

FIG. 4 is a detail view of an embodiment of the disclosure taken from Window 4 in FIG. 3.

FIG. 5 is a top view of an embodiment of the disclosure.

FIG. 6 is an exploded in-use view of an embodiment of the disclosure.

FIG. 7 is an in-use view of an embodiment of the disclosure.

FIG. 8 is a perspective in-use view of an embodiment of the disclosure.

### DETAILED DESCRIPTION OF THE INVENTION

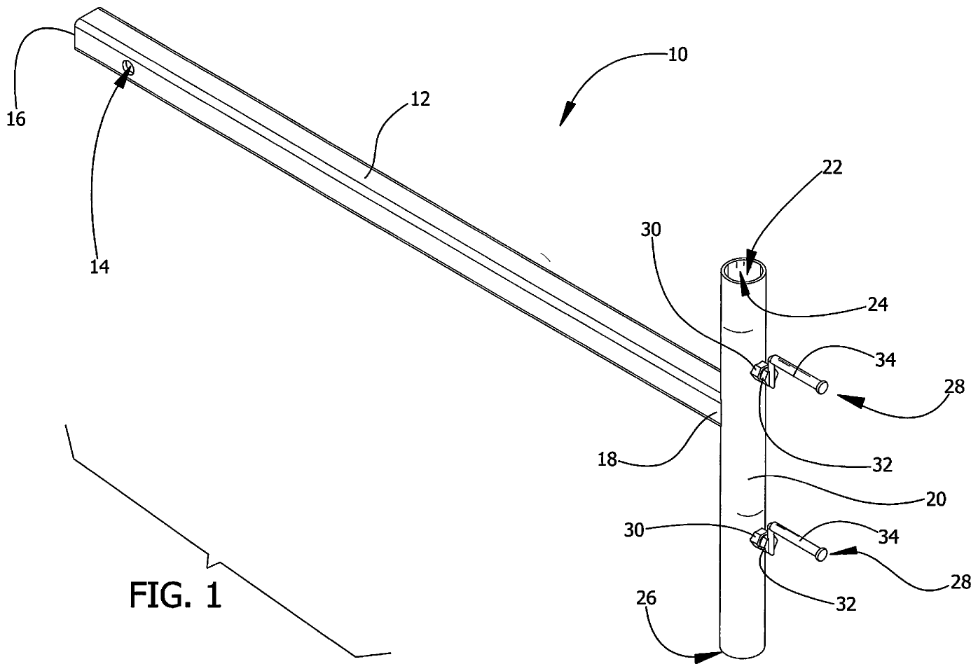

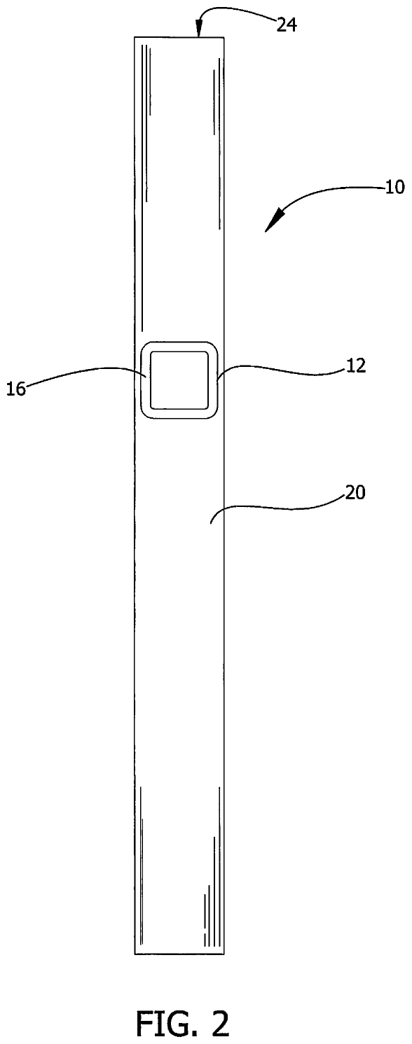

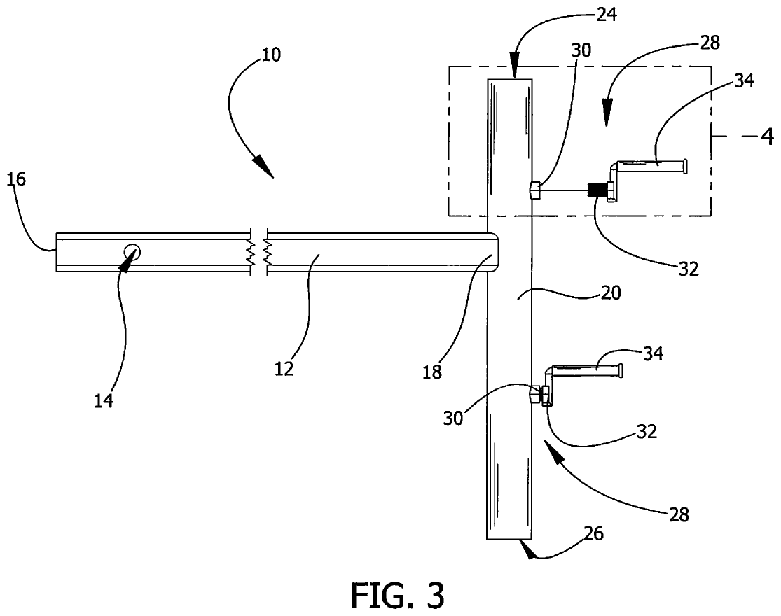

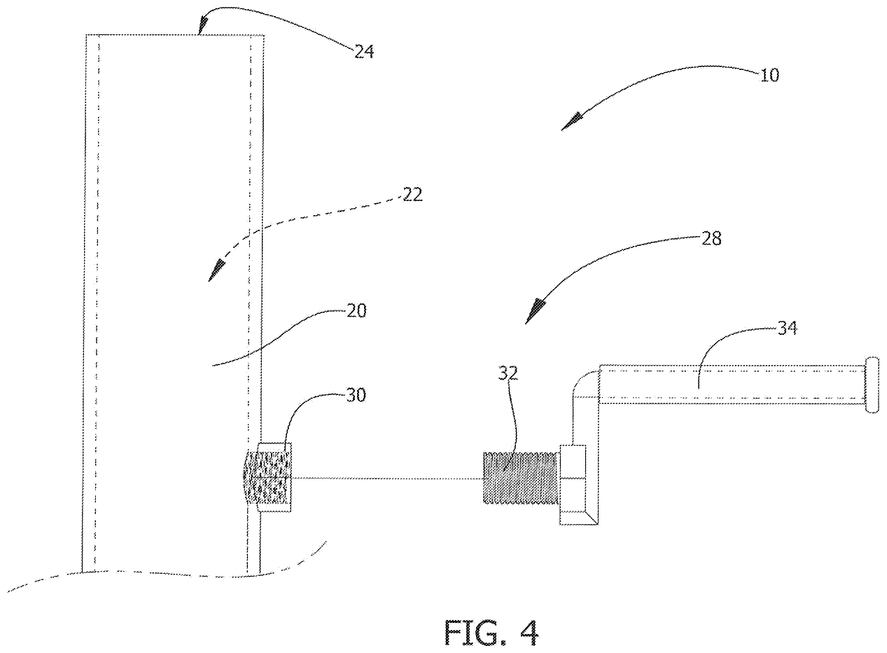

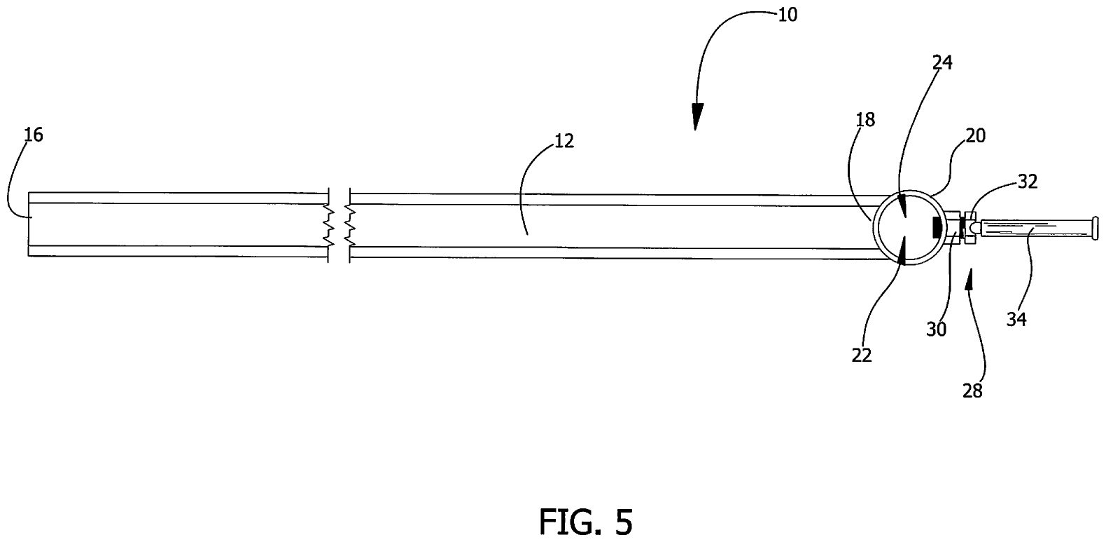

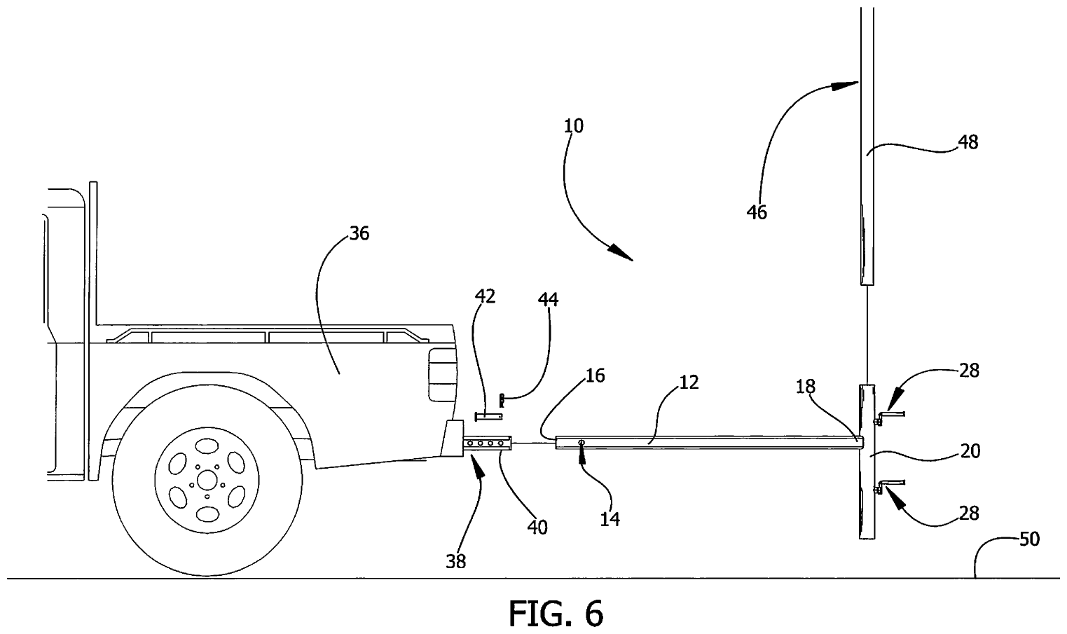

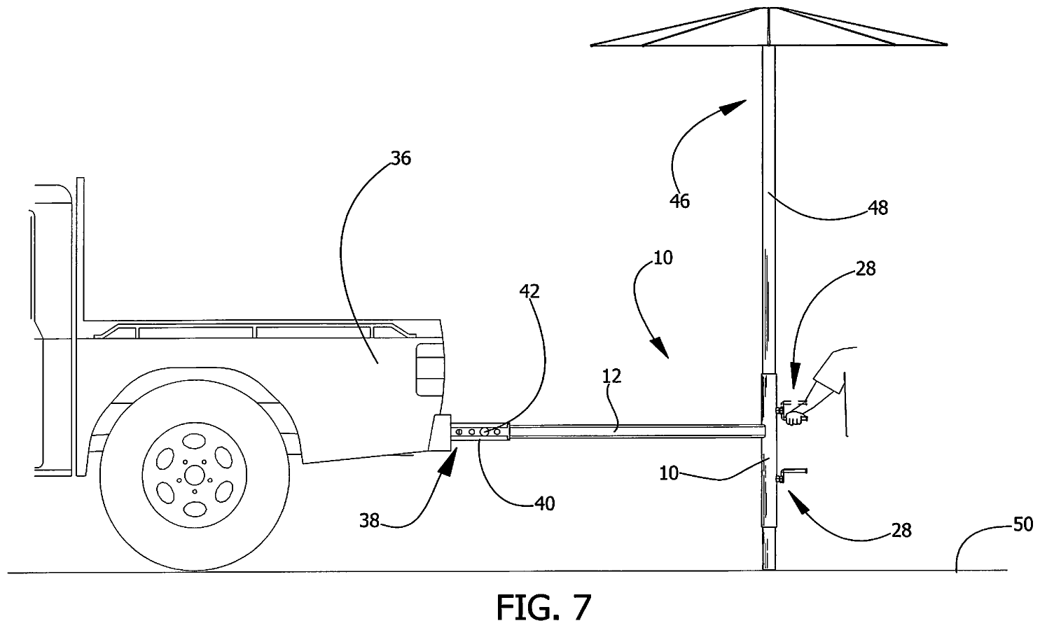

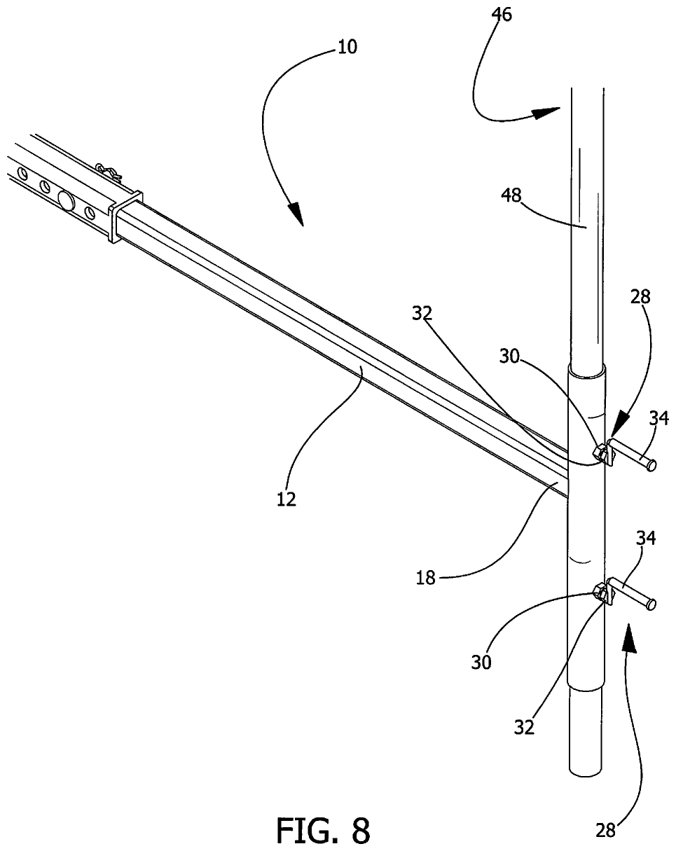

With reference now to the drawings, and in particular to FIGS. 1 through 8 thereof, a new umbrella mount embodying the principles and concepts of an embodiment of the disclosure and generally designated by the reference numeral 10 will be described.

As best illustrated in FIGS. 1 through 8, the umbrella mount apparatus 10 generally comprises a hitch beam 12 sized and configured to be received into a receiver tube 40 of a hitch 38 of a vehicle 36. The hitch beam 12 has a hole 14 which extends therethrough near a first end 16 of the hitch beam 12. The hole 14 is positioned and configured to mount to the receiver tube 40 via a hitch pin 42. The hitch pin 42 may be secured in the hole 14 of the hitch beam 12 and to the receiver tube 40 via a hairpin 44, a cotter pin, or the like. An umbrella-holding tube 20 is coupled to the hitch beam 12 at a second end 18 of the hitch beam 12 opposite the first end 16. The umbrella-holding tube 20 defines a channel 22 sized and configured for receiving a shaft 48 of an umbrella 46 therethrough. The channel 22 has an open top end 24 and an open bottom end 26, which allows the shaft 48 of the umbrella 46 to extend completely through the channel 22.

A pair of retainers 28 is configured to be operable to secure the shaft 48 of the umbrella 46 in a desired position in the umbrella-holding tube 20. Each retainer 28 of the pair of retainers 28 comprises a threaded receiver 30, a set screw 32, and a handle 34. The threaded receiver 30 of each retainer 28 is mounted to the umbrella-holding tube 20. The threaded receivers 30 of the pair of retainers 28 are spaced from each other in a longitudinal direction of the umbrella-holding tube 20. The set screw 32 is engageable with the threaded receiver 30 via rotation therein to move the set screw 32 alternately into and out of the channel 22 of the umbrella-holding tube 20. The handle 34 is mounted to the set screw 32. The handle 34 has an elongated shape and is oriented parallel to and offset from a center axis of the set screw 32. The elongated shape is cylindrical but may have other shapes. For example, the elongated shape may be an elongated square prism, an elongated hexagonal prism, or the like. In other embodiments, the retainers 28 may comprise other types of clamps, threaded fasteners, latches, or the like.

In use, the hitch beam 12 is secured to the receiver tube 40 of the hitch 38 via the hitch pin 42. The shaft 48 of the umbrella 46 is inserted into the umbrella-holding tube 20 and is positioned at the desired position. The shaft 48 may extend completely through the channel 22 of the umbrella-holding tube 20 and rest atop a support surface 50 such as the ground. The support surface 50 may be the only support holding the umbrella 46 up, with the umbrella-holding tube 20 serving only to orient the shaft 48 of the umbrella 46, thereby preventing the umbrella 46 from tipping over. Or the shaft 48 may rest atop the support surface 50 and the retainers 28 may be engaged to secure the shaft 48 to the umbrella-holding tube 20, thereby supporting the hitch beam 12 in part via the umbrella 46.

In yet other uses, the desired position of the shaft 48 may be above the support surface 50, and the umbrella 46 may be held in the desired position via the retainers 28 only. To secure the shaft 48 of the umbrella 46 to the umbrella-holding tube 20 via the retainers 28, the set screw 32 of each retainer 28 may be screwed through the associated threaded receiver 30 by grasping the associated handle 34 and rotating the set screw 32 with respect to the associated threaded receiver 30. The handles 34 are oriented parallel to the respective set screws 32 to facilitate the handles 34 rotating within a hand when the hand grasps one of the handles 34. The threaded fasteners are spaced from each other in the longitudinal direction of the umbrella-holding tube 20 to align a central longitudinal axis of the shaft 48 of the umbrella 46 with a central longitudinal axis of the umbrella-holding tube 20. This is especially helpful in the event the shaft 48 is substantially thinner than the channel 22 of the umbrella-holding tube 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An umbrella mount apparatus for a hitch of a vehicle, the apparatus comprising:
a hitch beam sized and configured to be received into a receiver tube of the hitch, the hitch beam having a hole extending therethrough near a first end of the hitch beam, the hole being positioned and configured to mount to the receiver tube via a hitch pin;
an umbrella-holding tube being coupled to the hitch beam at a second end of the hitch beam opposite the first end, the umbrella-holding tube defining a channel sized and configured for receiving a shaft of an umbrella therethrough, the channel having an open top end and an open bottom end; and
a retainer configured to be operable to secure the shaft of the umbrella in a desired position in the umbrella-holding tube.

2. The apparatus of claim 1, wherein the retainer is one of a pair of retainers configured to be operable to secure the shaft of the umbrella in a desired position in the umbrella-holding tube.

3. The apparatus of claim 2, wherein the pair of retainers are coupled to the umbrella-holding tube, the pair of retainers being spaced from each other in a longitudinal direction of the umbrella-holding tube.

4. The apparatus of claim 1, wherein the retainer comprises:
a threaded receiver mounted to the umbrella-holding tube; and
a set screw engageable with the threaded receiver, the set screw being rotatable in the threaded receiver to move the set screw alternately into and out of the channel of the umbrella-holding tube.

5. The apparatus of claim 4, wherein the retainer further comprises a handle mounted to the set screw, the handle having an elongated shape, the handle being oriented parallel to and offset from a center axis of the set screw.

6. The apparatus of claim 5, wherein the elongated shape is cylindrical.

7. An umbrella mount apparatus for a hitch of a vehicle, the apparatus comprising:
a hitch beam sized and configured to be received into a receiver tube of the hitch, the hitch beam having a hole extending therethrough near a first end of the hitch beam, the hole being positioned and configured to mount to the receiver tube via a hitch pin;
an umbrella-holding tube being coupled to the hitch beam at a second end of the hitch beam opposite the first end, the umbrella-holding tube defining a channel sized and configured for receiving a shaft of an umbrella therethrough, the channel having an open top end and an open bottom end; and
a pair of retainers configured to be operable to secure the shaft of the umbrella in a desired position in the umbrella-holding tube, each retainer of the pair of retainers comprising:
a threaded receiver mounted to the umbrella-holding tube, the threaded receivers of the pair of retainers being spaced from each other in a longitudinal direction of the umbrella-holding tube;
a set screw engageable with the threaded receiver, the set screw being rotatable in the threaded receiver to move the set screw alternately into and out of the channel of the umbrella-holding tube; and
a handle mounted to the set screw, the handle having an elongated shape, the handle being oriented parallel to and offset from a center axis of the set screw, the elongated shape being cylindrical.
